(19) United States
(12) Patent Application Publication
(10) Pub. No.: US 2004/0033325 A1
(43) Pub. Date: Feb. 19, 2004

(54) Body applique

(76) Inventors: Kim M. Shea, Westboro, MA (US); Adina Levin, New York, NY (US)

Correspondence Address: LERNER AND GREENBERG, P.A., Post Office Box 2480, Hollywood, FL, 33022-2480, US

(21) Appl. No.: 10/426,944

(22) Filed: Apr. 30, 2003

Related U.S. Application Data
(60) Provisional application No. 60/376,516, filed on Apr. 30, 2002.

(51) Int. Cl. B32B 9/00

(52) U.S. Cl. 428/40.1

(57) ABSTRACT

The body appliqué includes an ornamental layer and an adhesive. The ornamental layer has a front and a back. The adhesive is disposed on the back and is for attaching to skin.

### CROSS-REFERENCE TO RELATED APPLICATION

This application claims the benefit of U.S. Provisional Application No. 60/376,516 filed Apr. 30, 2002.

### BACKGROUND OF THE INVENTION

1. Field of the Invention

The invention relates to body appliqués and, in particular, to cloth body appliqués that attach to a user's skin.

2. Description of the Related Art

Tattoos permanently decorate a wearer's skin. However, due to their permanence, wearers only use them when they want to mark themselves permanently.

Novelty temporary tattoos and body paint are alternatives to permanent tattoos. Novelty tattoos allow a wearer to temporarily decorate their skin. Because they are temporary, novelty tattoos can contain designs and even advertisements that are interesting to the wearer in only the short term.

Novelty tattoos press onto the skin and remain for several days. With time, they peel off in pieces. As they peel partially peel, the wearer is left with only parts of their tattoo. Usually, novelty tattoos can be quickly and completely removed by using a solvent. Unfortunately, solvents are often dangerous and are not readily available.

Body paints have the opposite problem from temporary tattoos. Body paints often wash off too easily with water. The wearers usually complain that the body paint does not last long enough.

In fields unrelated to body appliqués, technical innovations have occurred in adhesives, sound players, and liquid crystals.

Regarding adhesives, 3M® corporation has developed polyethylene adhesives used in bandages such as those sold under the tradename 1522 DOUBLE COATED MEDICAL TAPE. This medical tape includes a polyethylene adhesive that adheres a bandage to a patient's skin and that can be removed without damaging the skin.

In the field of liquid crystals, Liquid Crystal Resources, Inc. has produced a series of temperature-sensitive liquid-crystal films. These liquid-crystal films are used to make thermometers for fish tanks and baths.

In the field of semiconductors, thin pressure-sensitive sound player have been constructed that can playback short digitized sound clips through a self-contained speaker.

### SUMMARY OF THE INVENTION

It is accordingly an object of the invention to provide a body appliqué that overcomes the above-mentioned disadvantages of the heretofore-known devices and methods of this general type.

With the foregoing and other objects in view there is provided, in accordance with the invention, a body appliqué. The body appliqué includes an ornamental layer and an adhesive. The ornamental layer has a front and a back. The adhesive is disposed on the back and is for attaching to skin.

In accordance with a further object of the invention, the ornamental layer can include liquid crystals. The liquid crystals change color depending on temperature.

In accordance with a further object of the invention, the adhesive releasably attaches to the skin. In addition, the adhesive can be peeled from the skin without damaging the skin. The adhesive can be a transparent, three-millimeter thick polyethylene film. In addition to skin, the polyethylene film also can attach to clothing. The adhesive should also be water-resistant.

In accordance with a further object of the invention, the ornamental layer can include fabric, colors, glitter, sequins, rubber, and even glow in the dark. The ornamental layer also can include and incorporate precious metals such as gold, silver, copper, and platinum.

In accordance with a further object of the invention, the body appliqué includes a fragrance. To protect the color of the fabric, the fragrance can be water soluble.

In accordance with a further object of the invention, a scented disk can be disposed between the ornamental layer and the adhesive.

In accordance with a further object of the invention, a pressure-triggered sound-playing device can be disposed between the ornamental layer and the adhesive layer.

In accordance with a further object of the invention, the appliqué can include an insect repellant. The insect repellant can be added by adding a solution of insect repellant to the already-manufactured appliqué. Alternatively, a layer can be included between the adhesive and decorative layer that includes that includes an insect repellant.

With the objects of the invention in view, there is also provided a method for testing fragrances. The first step of the method is providing a body appliqué including an ornamental layer with a front and a back, an adhesive on the back of the ornamental layer, and a scent on the ornamental layer. The next step is attaching the body appliqué to a subject's skin.

With the objects of the invention in view, there is also provided a method for scenting a body appliqué including a colored cloth ornamental layer and a polyethylene adhesive layer includes spraying a water-soluble scent on the body appliqué.

Other features which are considered as characteristic for the invention are set forth in the appended claims.

Although the invention is illustrated and described herein as embodied in a body appliqué, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a section view of a body appliqué;

FIG. 2 is a sectional view of a body appliqué with a scented disk;

FIG. 3 is a sectional view of the body appliqué with a liquid-crystal layer and a sound playing device; and

FIG. 4 is a plan view of the body appliqué shown in FIG. 1.

### DESCRIPTION OF THE PREFERRED EMBODIMENTS

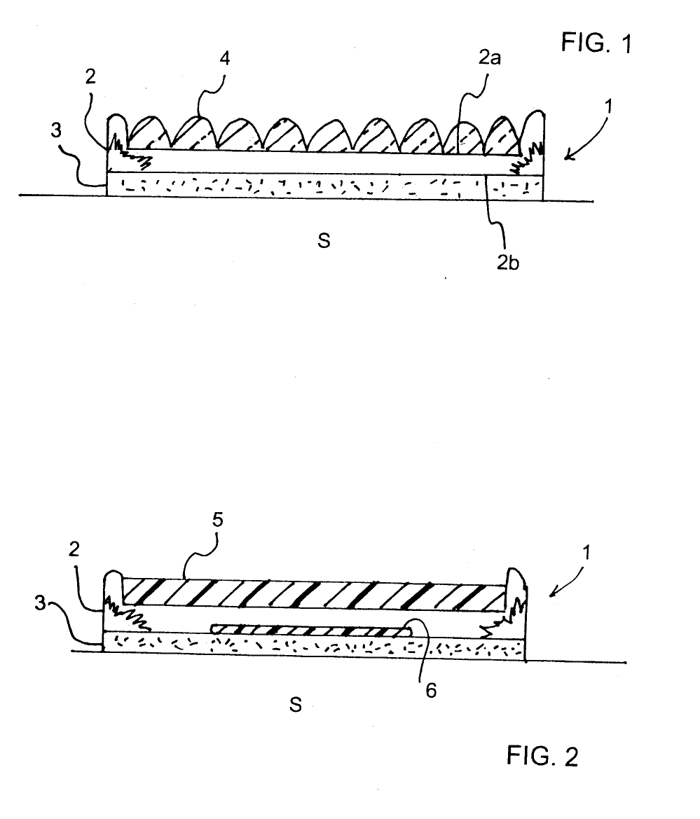

Referring now to the figures of the drawing in detail and first, particularly, to FIGS. 1 and 4 thereof, there is seen a sectional view of a body appliqué 1. The body appliqué 1 includes an ornamental layer 2 having a top 2a and a back 2b. An adhesive 3 is attached to the back 2b of the ornamental layer 2 and the skin S of the wearer.

The adhesive 3 is water-soluble polyethylene and is preferably three millimeters thick (3 mm). This adhesive attaches and holds to a wearer's skin S but can be peeled along with the ornamental layer 2 from the skin S without damaging the skin S.

Preferably, the ornamental 2 layer is colored cloth. Sequins 4 are attached to the front 2b of the ornamental layer.

A water-soluble scent can be sprayed on the ornamental layer 2. By being water soluble, the scent does not affect the color of the ornamental layer or the adhesive 3.

In the embodiment shown in FIG. 2, a temperature sensitive liquid crystal layer 5 is attached to the front 2b of the ornamental layer 2. The liquid crystal layer 5 changes color with changes in environmental temperature and/or body temperature.

The embodiment shown in FIG. 2 also includes a scented disc 6. The scented disc 6 is gas-permeable and releases a scent. The scented disk 6 can include an insect repellant.

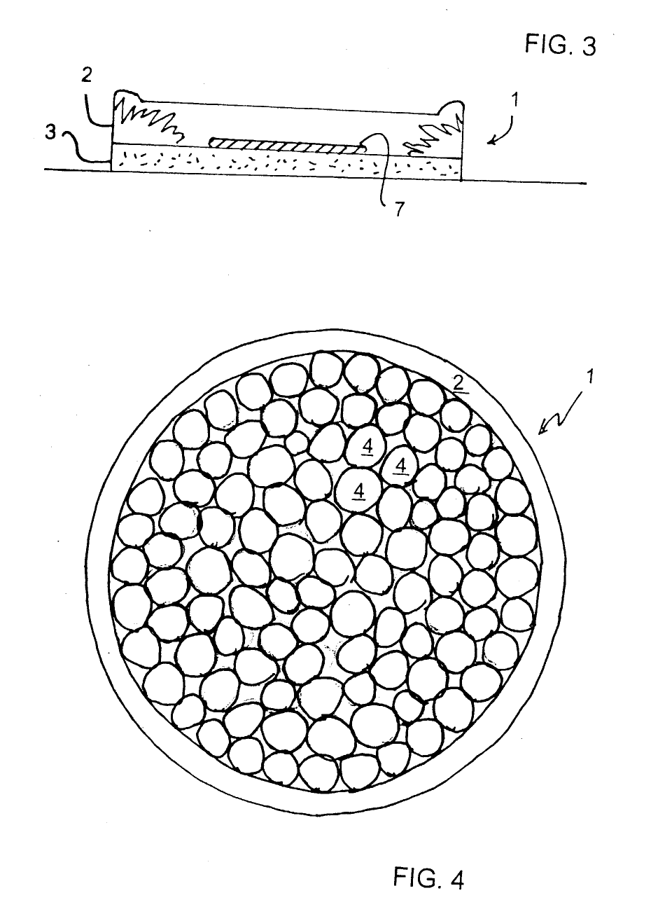

The embodiment shown in FIG. 3 includes a sound-playing device 7. Pressure triggers the sound-playing device 7. When triggered, the sound-playing device 7 plays a prerecorded sound.

I claim:

1. A body appliqué, comprising:
an ornamental layer having a front and a back; and
an adhesive on said back for attaching to skin.

2. The body appliqué according to claim 1, wherein said ornamental layer includes liquid crystals.

3. The body appliqué according to claim 2, wherein said liquid crystals change color depending on temperature.

4. The body appliqué according to claim 1, wherein said adhesive releasably attaches to the skin.

5. The body appliqué according to claim 4, wherein said adhesive can be peeled from the skin without damaging the skin.

6. The body appliqué according to claim 1, wherein said adhesive is a polyethylene film.

7. The body appliqué according to claim 6, wherein said polyethylene film is three millimeters thick.

8. The body appliqué according to claim 6, wherein said polyethylene film is transparent.

9. The body appliqué according to claim 1, wherein said polyethylene film also attaches to clothing.

10. The body appliqué according to claim 1, wherein said adhesive is water-resistant.

11. The body appliqué according to claim 1, wherein said ornamental layer includes a fabric.

12. The body appliqué according to claim 1, wherein said ornamental layer includes colors.

13. The body appliqué according to claim 12, wherein said colors glow in the dark.

14. The body appliqué according to claim 1, wherein said ornamental layer includes glitter.

15. The body appliqué according to claim 1, wherein said ornamental layer includes sequins.

16. The body appliqué according to claim 1, wherein said ornamental layer includes rubber.

17. The body appliqué according to claim 1, including a fragrance.

18. The body appliqué according to claim 17, wherein said fragrance is water soluble.

19. The body appliqué according to claim 1, including an insect repellant.

20. The body appliqué according to claim 1, including a scented disk being disposed between said ornamental layer and said adhesive.

21. The body appliqué according to claim 20, wherein said scented disk includes an insect repellant.

22. The body appliqué according to claim 1, including a pressure-triggered sound playing device being disposed between said ornamental layer and said adhesive layer.

23. The body appliqué according to claim 1, wherein said ornamental layer includes a precious metal.

24. The body appliqué according to claim 23, wherein said precious metal is selected from the group consisting of gold, silver, copper, and platinum.

25. A method for testing fragrances, which comprises:
providing a body appliqué including an ornamental layer with a front and a back, an adhesive on the back of the ornamental layer, and a scent on the ornamental layer; and
attaching the body appliqué to a subject's skin.

26. A method for scenting a body appliqué including a colored cloth ornamental layer and a polyethylene adhesive layer, which comprises spraying a water-soluble scent on the body appliqué.
